(19) United States
(12) Patent Application Publication
(10) Pub. No.: US 2009/0321148 A1
(43) Pub. Date: Dec. 31, 2009

(54) TOUCH PANEL DEVICE AND CIRCUITRY THEREOF

(75) Inventors: YU MIN HSU, HSIN-CHU (TW); CHIA FENG YANG, HSIN-CHU (TW); CHEN HSIANG HO, HSIN-CHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: AU OPTRONICS CORPORATION, HSIN-CHU (TW)

(21) Appl. No.: 12/399,342

(22) Filed: Mar. 6, 2009

(30) Foreign Application Priority Data
Jun. 27, 2008 (TW) 097124060

(51) Int. Cl. G08C 21/00

(52) U.S. Cl. 178/18.03; 178/20.01

(57) ABSTRACT

A touch panel circuitry, which is coupled to a controller, comprises a plurality of electrode strips and a plurality of conductive traces. The electrode strip configured to provide touch signals has two strip ends. The conductive trace is configured for electrically coupling the two strip ends of the corresponding electrode strip so as to form a closed loop circuit. Each conductive trace is also connected to the controller to transmit signals generated by the corresponding electrode strip.

### BACKGROUND OF THE INVENTION

1. Field of the Invention

The present invention relates to a touch panel device and the circuitry thereof, and more particularly, to a touch panel device and the circuitry thereof generating touch signals with higher electrical potential energy.

2. Description of the Related Art

Although touch panel technology has been adopted for many electronic apparatuses, for example notebook computers with touch screens, personal digital assistants and automated teller machines, more electronic apparatuses will adopt this technology in the near future due to advantages such as simplicity, intuitive-use capability, natural function, space saving feature and suitability of multimedia, and it will likely become one of the major user interface types in the future.

FIG. 1 shows a related art touch panel device 100. Using touch panel technology, a graphic user interface can be manipulated by a touch panel device 100 generating signals by touching, which are transmitted via conductive traces 102 to a controller 104 and are used to determine the coordinates of the touch position. Generally, the signals from the touch panel device 100 caused by touching are generated by a touch sensor array 106, which comprises electrode strips 108 (horizontally disposed) and 110 (vertically disposed). Conductive traces 102 configured for transmitting the signals to the controller 104 are disposed on one horizontal or vertical side of the touch panel device 100, each of which is connected to one strip end of the corresponding electrode strip 108.

Referring to FIG. 2, the conductive trace 102 is connected to the left end point, Point B, of the touch sensor array 106. The electrical resistance of the conductive trace 102 between Point A and Point B is R₁ and the electrical resistance of the electrode strip 108 (using row 1 for example) between the left end point and the right end point, Point C, is R₂. The electrical resistance R′, between Point A and Point C, is the sum of R₁ and R₂ namely, R′=(R₁+R₂) and the circuit as shown in FIG. 2 can be represented by an equivalent circuit model as shown in FIG. 3. Consequently, because each electrode strip 108 has only one end connected to the controller 104, the electrode strip's other end portion away from the trace 102 has a long conductive route and suffers from higher electrical resistance. High electrical resistance causes a decrease in signal strength at the output, resulting in significant signal loss or distortion so as to influence touching sensitivity. As the size of a touch panel device 100 increases, the high resistance issue becomes more serious and the signal strength decreases more significantly. Therefore, a solution is urgently required.

### SUMMARY OF THE INVENTION

The present invention proposes a touch panel device and the electrical circuit thereof, which has a shorter signal transmission path and thereby effectively minimizes the electrical potential energy reduction through the electrical circuitry of the touch panel device. The touch panel device includes the electrical strip that can generate touch signals with higher and more evenly distributed electrical potential energy, and thereby provides more reliable touch sensitive control in response to touching.

The present invention proposes a touch panel circuitry design that is coupled to a controller and comprises a plurality of first electrode strips and a plurality of first conductive traces. The first electrode strips are disposed substantially parallel to each other and are configured for generating a touch signal, wherein each first electrode strip comprises two strip ends. Each of the first conductive traces is configured for electrically coupling the two strip ends of the corresponding first electrode strip to form a closed loop circuit and to transmit the touch signal generated therefrom to the controller.

The present invention proposes a touch panel device, which comprises a touch panel circuitry as described above and a controller, which is electrically coupled to the first electrode strips and is configured for detecting a touch position.

In one embodiment, the first electrode strips are disposed along a first direction and the touch panel circuitry further comprises a plurality of substantially parallel second electrode strips, which are configured for generating a touch signal and are arrayed along a second direction, wherein the first direction and the second direction can be mutually orthogonal.

### BRIEF DESCRIPTION OF THE DRAWINGS

The invention will be described according to the appended drawings in which:

FIG. 1 shows a related art touch panel device;

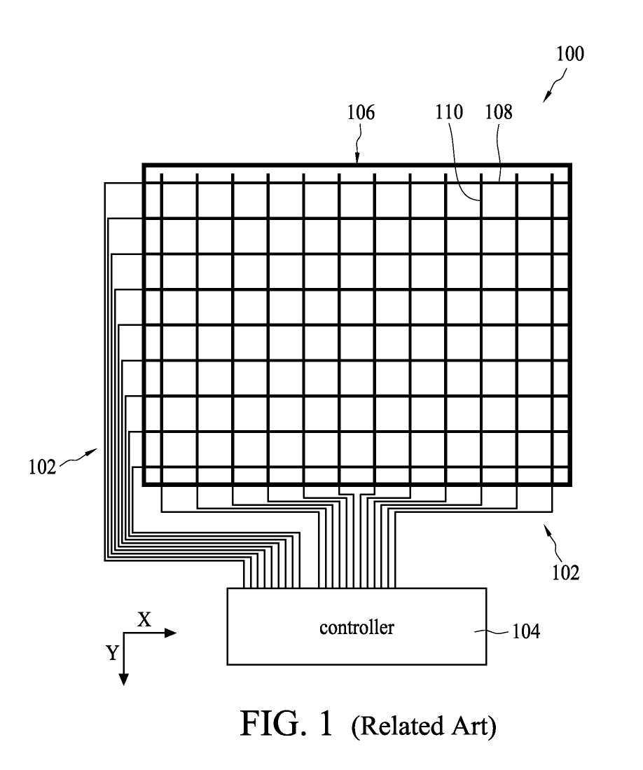

FIG. 2 shows an electrode strip circuit of the related art touch panel device in FIG. 1;

FIG. 3 shows an equivalent circuit model of the electrode strip circuit in FIG. 2;

FIG. 4 shows a touch panel device according to one embodiment of the present invention;

FIG. 5 shows a closed loop first electrode strip circuit according to one embodiment of the present invention;

FIG. 6 shows an equivalent circuit model of the closed loop first electrode strip circuit in FIG. 5;

FIG. 7A shows the positions of measuring the electrical potential energy of a closed loop first electrode strip circuit according to one embodiment of the present invention;

FIG. 7B is a diagram showing the electrical potential energy of a closed loop first electrode strip circuit according to one embodiment of the present invention, compared to the electrical potential energy of a related art circuit; and

FIG. 8 shows a touch panel device according to another embodiment of the present invention.

### DETAILED DESCRIPTION OF THE INVENTION

The present invention provides a touch panel device and the electrical circuit thereof, which has a shorter signal transmission path and thereby reduces the electrical potential energy loss, making the touch panel device more sensitive.

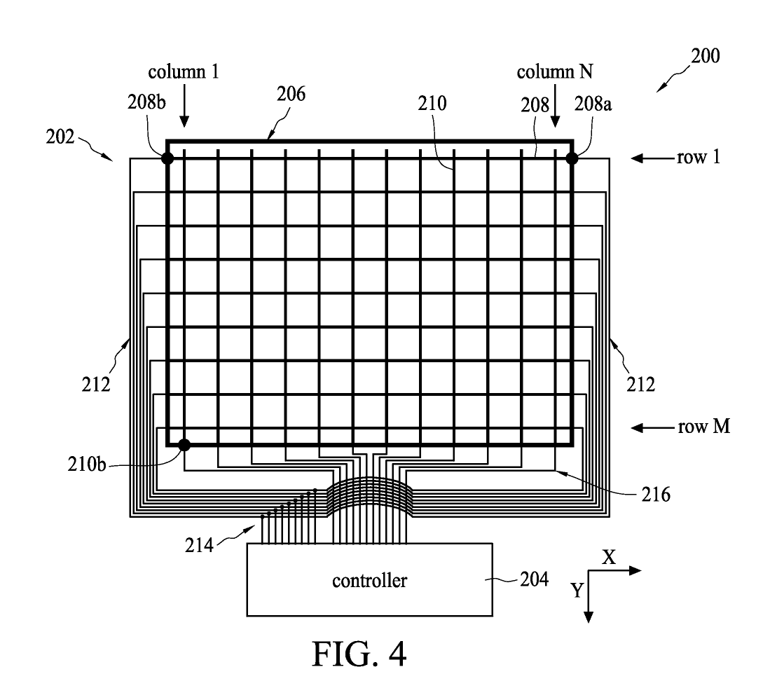

FIG. 4 shows a touch panel device 200 according to one embodiment of the present invention. The touch panel device 200 comprises a touch panel circuitry 202 and a controller 204. The touch panel circuitry 202 comprises a sensing element array 206 that is configured to generate touch signals and is formed by interlacing a plurality of first electrode strips 208 and a plurality of second electrode strips 210. The first electrode strips 208 are disposed along the X-direction and are arranged substantially parallel to each other in a plurality of rows, numbered 1 to M, wherein M is an integer and also represents the row number of the sensing element array 206. Each first electrode strip 208 comprises two strip ends 208a and 208b. The second electrode strips 210 are disposed along the Y-direction and are arranged substantially parallel to each other in a plurality of columns, numbered 1 to N, wherein N is an integer and also represents the column number of the sensing element array 206. In one embodiment, the directions of X and Y can be mutually orthogonal. Each of the electrode strips 208 and the second electrode strips 210 can comprise a plurality of serially connected touch pads (not shown). The first electrode strips 208 and the second electrode strips 210 can be made of a transparent material. In one embodiment, the transparent material can be indium tin oxide. The touch panel device 200 disclosed by the present invention can be a resistive touch panel device or a capacitive touch panel device, wherein the capacitive touch panel device is preferred.

A plurality of conductive traces 212 configured to transmit touch signals are disposed around the sensing element array 206 and are electrically coupled to the strip ends 208a and 208b of the respective first electrode strip 208 so that each first electrode strip 208 and the respective conductive trace 212 thereof form a closed loop circuit and thereby effectively minimize the loss of electrical potential energy and increase touching sensitivity. Each first strip electrode 212 is electrically coupled to the controller 204 by a respective conductive trace 214 so that the controller 204 can receive the touch signals or deliver control signals to the sensing element array 206. The controller 204 responsible for human-machine interaction transformation is used to control the sensing element array 206 and calculate the position of touch signals generated from the sensing element array 206. In the present embodiment, touch signals generated from each second electrode strip 210 are transmitted through a respective conductive trace 216, which electrically couples one strip end 210b of the second electrode strip 210 to the controller 204.

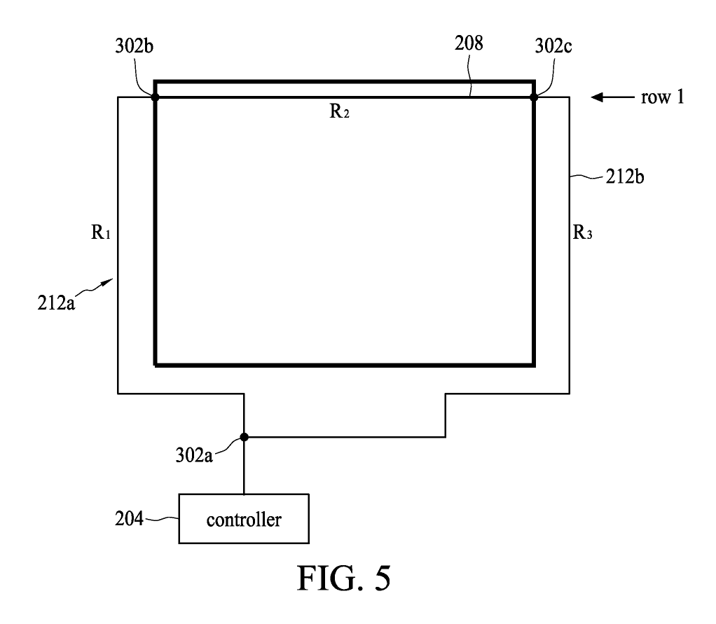

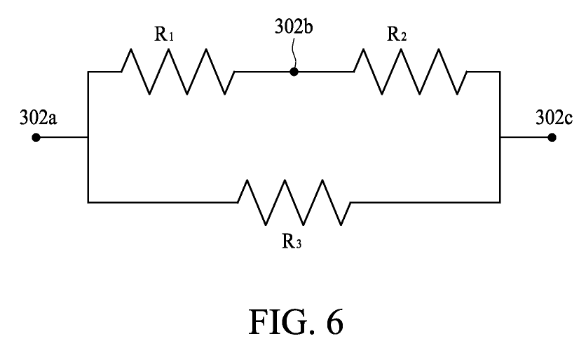

FIG. 5 shows a closed loop first electrode strip circuit according to one embodiment of the present invention. The minimization of the electrical potential energy loss through the electrical circuitry of the touch panel device 200 will be explained as follows by taking an example of the closed loop first electrode strip circuit (Row 1) shown in FIG. 5. The closed loop first electrode strip circuit is substantially divided into three portions: the conductive trace portion 212a, which is between the connection point 302a and the connection point 302b, and has a resistance R₁; the first electrode strip 208, which is between the connection point 302b and the connection point 302c, and has a resistance R₂; the conductive trace portion 212b, which is between the connection point 302c and the connection point 302a, and has a resistance R₃. The electrical resistance of the closed loop first electrode strip circuit can be modeled by an equivalent circuit model of the closed loop first electrode strip circuit as shown in FIG. 6. According to the equivalent circuit model, the electrical resistance of the closed loop first electrode strip circuit can be calculated by an equation as follows:

$$R = ( {R}_{1} + {R}_{2} ) \frac{{R}_{3}}{{R}_{1} + {R}_{2} + {R}_{3}}$$

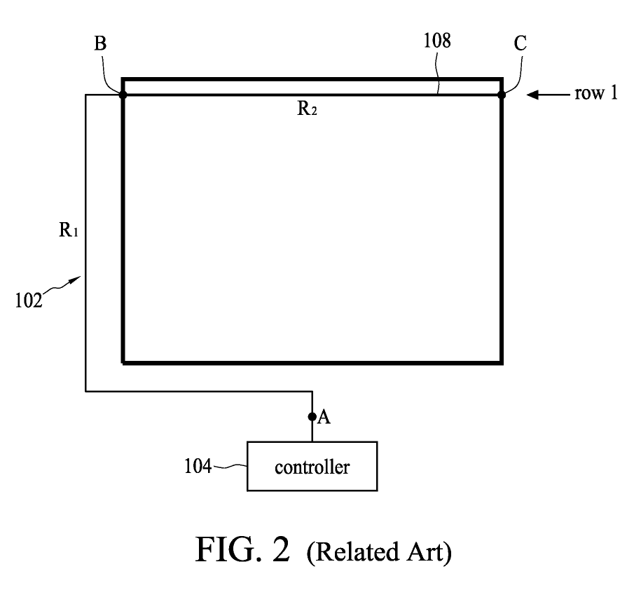

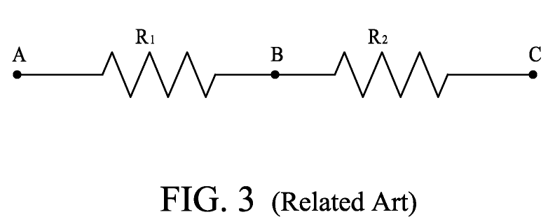

Compared to the related art touch panel device 100 (as shown in FIG. 2 and FIG. 3), which has electrical resistance R′=(R₁+R₂), the electrical resistance of the closed loop first electrode strip circuit is smaller (R<R′). The technology disclosed by the present invention could significantly lower the electrical resistance between the connection point 302a and the connection point 302b, and therefore the signal loss can be reduced so as to minimize the reduction in the electrical potential energy and make the touch panel device 200 more sensitive.

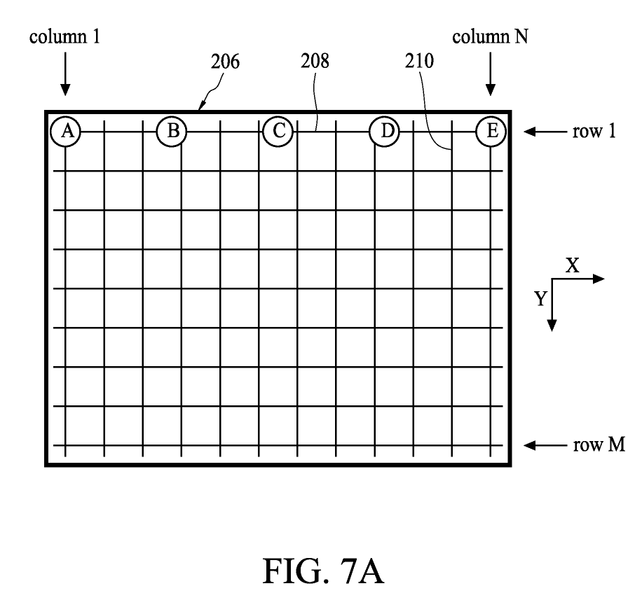

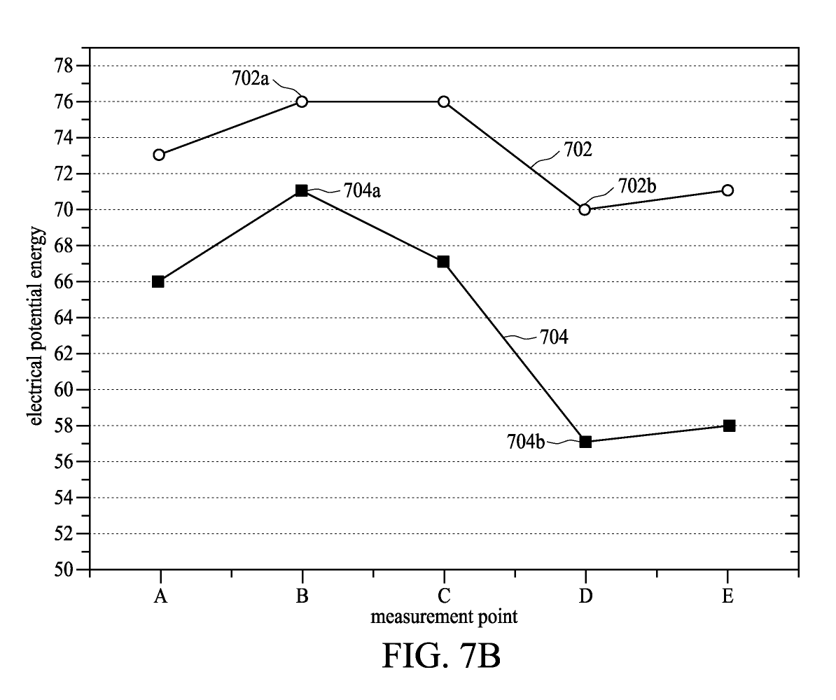

FIG. 7A shows the positions of measuring the electrical potential energy of a closed loop first electrode strip circuit according to one embodiment of the present invention. The electrical potential energy of a closed loop first electrode strip circuit is measured at the measurement points A, B, C, D, and E, which are equally spaced from left to right on the first electrode strip 208 (Row 1). FIG. 7B is a diagram showing the electrical potential energy of a closed loop first electrode strip circuit and a related art circuit according to one embodiment of the present invention. The curve 702 represents the measured electrical potential energy of the closed loop first electrode strip circuit of the present invention, and the curve 704 represents the result of a related art circuit. FIG. 7B clearly shows that the energy value of each measurement point of the curve 702 is higher than the energy value of the corresponding measurement point of the curve 704, and the comparison result indicates the touch panel device 202 of the present invention can generate touch signals with higher electrical potential energy. Furthermore, the variance range between the highest energy value and the lowest energy value in the curve 702 is about 6 energy units, while the variance range between the highest energy value and the lowest energy value in the curve 704 is about 14 energy units. Such a difference in variance ranges indicates that besides minimizing electrical potential energy reduction, the configuration of the first electrode strip 208 can distribute the electrical potential energy of the first electrode strip 208 more evenly.

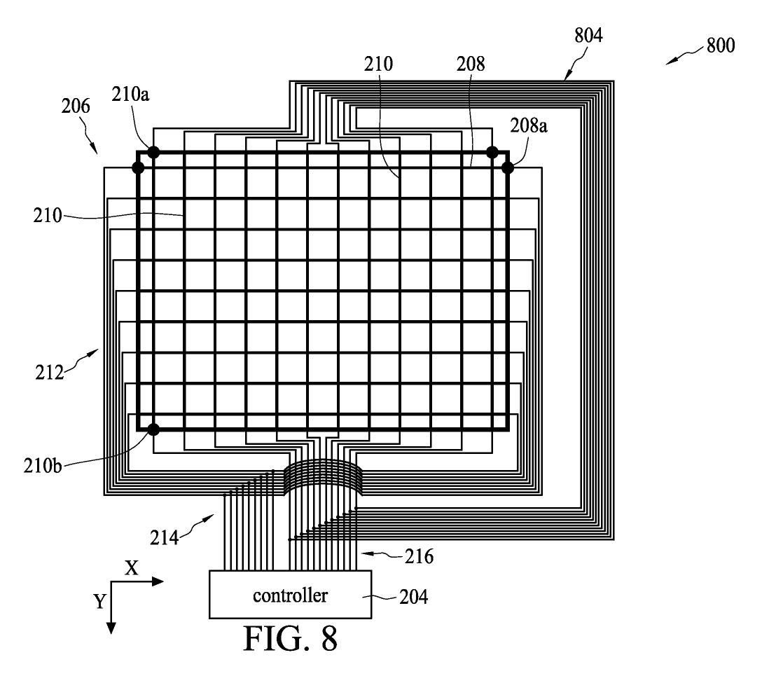

FIG. 8 shows a touch panel device 800 according to another embodiment of the present invention. Just as the first electrode strips 208 are connected in closed loop circuits as described above, the second electrode strips 210 can also be connected in closed loop circuits. A plurality of conductive traces 804 disposed at one side of the sensing element array 206 are electrically coupled to both strip ends of the respective second electrode strips to form closed loop circuits. Consequently, the second electrode strips 210 can also minimize the reduction in the electrical potential energy in touch signals.

The above-described embodiments of the present invention are intended to be illustrative only. Numerous alternative embodiments may be devised by persons skilled in the art without departing from the scope of the following claims.

What is claimed is:

1. A touch panel circuitry coupled to a controller, comprising:
a plurality of substantially parallel first electrode strips configured for generating a touch signal, wherein each first electrode strip comprises two strip ends; and
a plurality of first conductive traces, each of the first conductive traces being configured for electrically coupling the two strip ends of the corresponding first electrode strip to form a closed-loop circuit and the closed-loop circuit coupled to the controller.

2. The touch panel circuitry of claim 1, wherein the first electrode strips are disposed along a first direction.

3. The touch panel circuitry of claim 2, further comprising:
a plurality of substantially parallel second electrode strips arrayed along a second direction, and being configured for generating a touch signal; and
a plurality of second conductive traces, each of the second conductive traces being configured for electrically coupling one strip end of the corresponding second electrode strip and the controller.

4. The touch panel circuitry of claim 3, wherein the first electrode strips and the second electrode strips are formed of transparent conductive material.

5. The touch panel circuitry of claim 4, wherein the transparent conductive material is indium tin oxide.

6. The touch panel circuitry of claim 3, wherein the first direction and the second direction are orthogonal.

7. A touch panel device, comprising:
a touch panel circuitry comprising:
a plurality of substantially parallel first electrode strips configured for generating a touch signal, wherein each first electrode strip has two strip ends; and
a plurality of first conductive traces, each of the conductive traces being configured for electrically coupling the two strip ends of the corresponding first electrode strip; and
a controller electrically coupled to each first electrode strip, configured for detecting a touch position.

8. The touch panel device of claim 7, wherein the first electrode strips are arrayed in a first direction.

9. The touch panel device of claim 8, further comprising:
a plurality of second electrode strips arrayed substantially in parallel in a second direction, and being configured for generating a touch signal; and
a plurality of second conductive traces, each of the second conductive traces being configured for electrically coupling one strip end of the corresponding second electrode strip to the controller.

10. The touch panel device of claim 9, wherein the first electrode strips and the second electrode strips are formed of transparent conductive material.

11. The touch panel device of claim 10, wherein the transparent conductive material is indium tin oxide.

12. The touch panel device of claim 9, wherein the first direction and the second direction are orthogonal.

13. A touch panel circuitry coupled to a controller, comprising:
a plurality of substantially parallel first electrode strips configured for generating a touch signal, wherein each first electrode strip comprises two strip ends; and
a plurality of first conductive traces, each of which is configured for electrically coupling the two strip ends of the corresponding first electrode strip and transmitting the touch signal generated therefrom to the controller.

14. The touch panel circuitry of claim 13, wherein the first electrode strips are disposed along a first direction.

15. The touch panel circuitry of claim 14, further comprising:
a plurality of substantially parallel second electrode strips arrayed along a second direction, and being configured for generating a touch signal; and
a plurality of second conductive traces, each of which is configured for electrically coupling one strip end of the corresponding second electrode strip and the controller.

16. The touch panel circuitry of claim 14, wherein the first electrode strips and the second electrode strips are formed of transparent conductive material.

17. The touch panel circuitry of claim 16, wherein the transparent conductive material is indium tin oxide.

18. The touch panel circuitry of claim 15, wherein the first direction and the second direction are orthogonal.
